(19) United States
(12) Patent Application Publication
(10) Pub. No.: US 2019/0213607 A1
(43) Pub. Date: Jul. 11, 2019

(54) Shopper Traffic Flow Visualization Based on Point of Sale (POS) Transaction Data

(71) Applicant: POINT INSIDE, INC., Bellevue, WA (US)

(72) Inventors: Geary EPPLEY, Bellevue, WA (US); Josh MARTI, Bellevue, WA (US); Jonathan Alan CROY, Bellevue, WA (US); James HINDEMAN, Bellevue, WA (US); Brandon FERGUSON, Bellevue, WA (US); Jared TOLMAN, Bellevue, WA (US)

(73) Assignee: POINT INSIDE, INC., Bellevue, WA (US)

(21) Appl. No.: 15/868,913

(22) Filed: Jan. 11, 2018

(51) Int. Cl. G06Q 30/02; G06F 17/30; G06Q 20/20

(52) U.S. Cl. CPC G06Q 30/0201; G06Q 30/0202; G06Q 20/20; G06F 17/30994

(57) ABSTRACT

Shopper traffic flow is determined based on a filtered set of point of sale (POS) transaction data. A location analytics system determines a presumed best route taken by a customer upon entrance to the store, in walking between each item purchased, and then to the checkout stand. A determination is generated based on filtered parameters to provide visualization of shopper traffic flow in a retail location. Filtered parameters include shoppers for a specific item, or specific brand, to generate a determination as to where those particular shoppers dwelled and experienced impressions. The location analytics server generates visibility into spatial product relationships based on real, POS purchase data, and based on spatial layout data for a given store.

### BACKGROUND OF THE INVENTION

### 1. Field of the Invention

The invention relates to analytical systems and methods for extracting shopper traffic flow, and impressions of items located in a retail store, based on point of sale (POS) transaction data and the physical location of items within the retail store.

### 2. Background of Related Art

The ‘location’ of an item for sale relates to the physical place within the store or venue where the item is located or displayed for purchase. ‘Items’ as used herein may refer to individual items in a product catalog, or can alternatively refer to clusters of items having at least one common attribute. Point of sale (POS) transactional data as used herein is presumed to include an identity of an item or items purchased, an identity of the particular checkout stand used for that purchase, and various other POS transactional data such as time purchased, date purchased. Location may also relate to a subset area within the store, for example, a shelf-location, a location of a clothing rack or fixture, or just a polygon shape area within a selling-department where merchandise can be placed for sale. In a general sense, ‘location’ is defined as a shape of area in the store that is smaller than a department. In disclosed embodiments the location may be a geographic area within the store of 3 feet by 3 feet. Apart from good precision, coverage (meaning how many items can be assigned with enough confidence) is also crucial for product location assignment.

Location-type analytics, in theory, can provide more detailed customer interaction information. Customer-carried location-type analytics on smartphones and other mobile devices was first developed based on the presence of an indoor location technology, and the ability to use shopper location data to tabulate the same data. However, in reality the number of users (shoppers who had a specific app installed, operating and authorized to allow for location monitoring-and used the app while shopping in a given store) is in practice rather low. Thus, unfortunately the resulting data with these type systems tends to be biased toward the habits of technically proficient users who would be using such an app. Moreover, it turns out that actual user data from such active consumer devices typically contains gaps created, e.g., by the user intermittently engaging the with app (e.g., in a search for nails) and then closing it and putting it in their pocket for the remainder of a given shopping visit. Thus, while in theory customer-carried analytics systems would provide more detailed customer interaction information, in reality it suffers from inadequate interest and full adoption by customers.

Furthermore, the accurate determination of physical location for all items in a store provides customers and store employees with the ability to efficiently keep on top of restocking and merchandizing efforts. Location information also provides the basis for accurate merchandizing analytics so that items might be placed—or removed entirely—in a way that maximizes profitability of the store. However, determination of the actual location of any given item, on any given day, within any given store of a large chain is a challenge, particularly given that the exact shelf or floor display locations of items may and do change daily. In fact, even the floor displays themselves may move from day to day, e.g., racks of clothing.

Store operators often have diagrams of stores, as well as planograms or other information regarding the location of many products within their stores. However, the information regarding even the intended location of specific products within one or more of the stores is often incomplete or missing. Needless to say, locating a specific item in any given store is hampered by incomplete or missing product location information, for which no locating guidance can be provided. Moreover, certain types of retail items such as apparel items are more prone to be placed in specific locations within stores without exactly following any relevant detailed planogram. Placement of individual items of apparel and such in many stores is often left to the discretion of local department and floor managers, rather than being scripted in advance.

Given the location of items within a store, analytics systems and methods, fine grain location analytics systems and methods, and A/B testing can improve the square-foot based profitability of a given store. Analytics systems and methods all can benefit greatly from a system and method that determines more detailed customer interaction information.

There is a need for improved analytical systems, for passive analytical systems that do not require active acceptance and adoption by customers, to enable improved efficiency and profitability of any given store.

### SUMMARY OF THE INVENTION

In accordance with the present invention, a method of generating item location based shopper dwell based on point of sale transaction data in a store, the method comprising associating a physical location to a plurality of bays in a store, each of the plurality of bays including at least one of a plurality of items available at the store. Point of sale (POS) transaction data is obtained for the store. The POS transaction data is filtered to receipts based on at least one of a date and time of purchase, and further filtering the POS transaction data to receipts based on at least one parameter of items purchased, to obtain filtered receipts. An assigned location of each item purchased in the filtered receipts is obtained. The dwell locations of each item purchased on each of the filtered receipts are determined. The dwell locations are sorted based on a particular attribute of the items dwelled upon into a column or row, and visually output for the sorted column or row of particular attribute of the items dwelled upon.

In accordance with another aspect of the invention, a method of generating item location based shopper impressions based on point of sale transaction data in a store, the method comprising associating a physical location to a plurality of bays in a store, each of the plurality of bays including at least one of a plurality of items available at the store. Point of sale (POS) transaction data is obtained for the store. The POS transaction data is filtered to receipts based on at least one of a date and time of purchase, and further filtering the POS transaction data to receipts based on at least one parameter of items purchased, to obtain filtered receipts. An assigned location of each item purchased in the filtered receipts is obtained. A plurality of travel nodes are defined between each item purchased on each of the filtered receipts. A best route in the store is determined for each of the plurality of travel nodes. Impression locations of each bay passed along the plurality of travel nodes are determined. The impression locations are sorted based on a particular attribute of the items impressed upon into a column or row, and visually output for the sorted column or row of particular attribute of the items impressed upon.

In accordance with yet another aspect of the invention, a non-transient computer-readable storage medium having stored thereon instructions that, when executed on a processor, configure the processor to generate item location based shopper impressions based on point of sale transaction data in a store, by associating a physical location to a plurality of bays in a store, each of the plurality of bays including at least one of a plurality of items available at the store. Point of sale (POS) transaction data is obtained for the store. The POS transaction data is filtered to receipts based on at least one of a date and time of purchase, and further filtering the POS transaction data to receipts based on at least one parameter of items purchased, to obtain filtered receipts. An assigned location of each item purchased in the filtered receipts is obtained. The dwell locations of each item purchased on each of the filtered receipts are determined. The dwell locations are sorted based on a particular attribute of the items dwelled upon into a column or row, and visually output for the sorted column or row of particular attribute of the items dwelled upon.

### BRIEF DESCRIPTION OF THE DRAWINGS

Features and advantages of the present invention will become apparent to those skilled in the art from the following description with reference to the drawings, in which:

FIG. 1 illustrates an exemplary product location analytics system including a product location analytics server and a product location database, in accordance with the principles of the present invention.

FIG. 2 is a functional block diagram of an exemplary product location analytics server computing device and relevant data structures and/or components thereof.

FIG. 3 is a functional block diagram of an exemplary product location database, in accordance with the principles of the present invention.

FIG. 4 shows input to a location analytics server in accordance with the principles of the present invention.

FIG. 5 shows an exemplary output function of the location analytics server wherein a “heat map” is generated by appropriate algorithms performed using the POS transaction data, and location of all items in the relevant store, in accordance with the principles of the present invention.

FIG. 6 shows an example of “impressions” for “3M” branded products, e.g., within a period of the past 30 days, depicted as a “heat map”, for a given store, generated by the location analytics server, in accordance with the principles of the present invention.

FIG. 7 shows an example of “dwells” for “3M” branded products, e.g., within a period of the past 30 days, depicted as a “heat map”, for a given store.

FIG. 8 shows an example of “dwells” for “Scotts” branded products, e.g., within a period of the past 30 days, depicted as a “heat map”, for a given store.

FIG. 9 shows an example of “impressions” for “Whirlpool” branded products, e.g., within a period of the past 30 days, depicted as a “heat map”, for a given store.

FIG. 10 shows another exemplary output function of the location analytics server wherein a “place attribution table” is generated by appropriate algorithms performed using the POS transaction data, and location of all items in the relevant store, in accordance with the principles of the present invention.

FIG. 11 shows an exemplary place attribution determination for “3M” brands purchased within the past 30 days based on Brands in a given store.

FIG. 12 shows an exemplary place attribution determination for “3M” brands purchased within the past 30 days based on Product Categories in a given store.

FIG. 13 shows an exemplary place attribution determination for “3M” brands purchased within the past 30 days based on Departments in a given store.

### DETAILED DESCRIPTION OF ILLUSTRATIVE EMBODIMENTS

To enable location-based analytics, a viable location assignment system is required which is capable of assigning a location to all items available for purchase in a store. In larger retail chain stores this can amount to many tens of thousands, or even over 100,000 items. A location assignment system determines location information within a given store for all items or products in a retailer's catalog. In general, items in the store are misplaced, moved, re-arranged, or simply out of stock, and over time their locations in the store can become unknown. The location-based analytics provided herein work best with a location system capable of determining a physical location of 100% of products in a retail system - even when such products tend to move around a store from day to day.

Suitable location assignment systems have been disclosed in other applications co-owned with the present invention. For instance, one suitable location assignment system based on point of sale (POS) transaction data is disclosed in U.S. application Ser. No. 15/833,402 entitled “Transaction Based Location Assignment System and Method”, the entirety of which is expressly incorporated herein by reference.

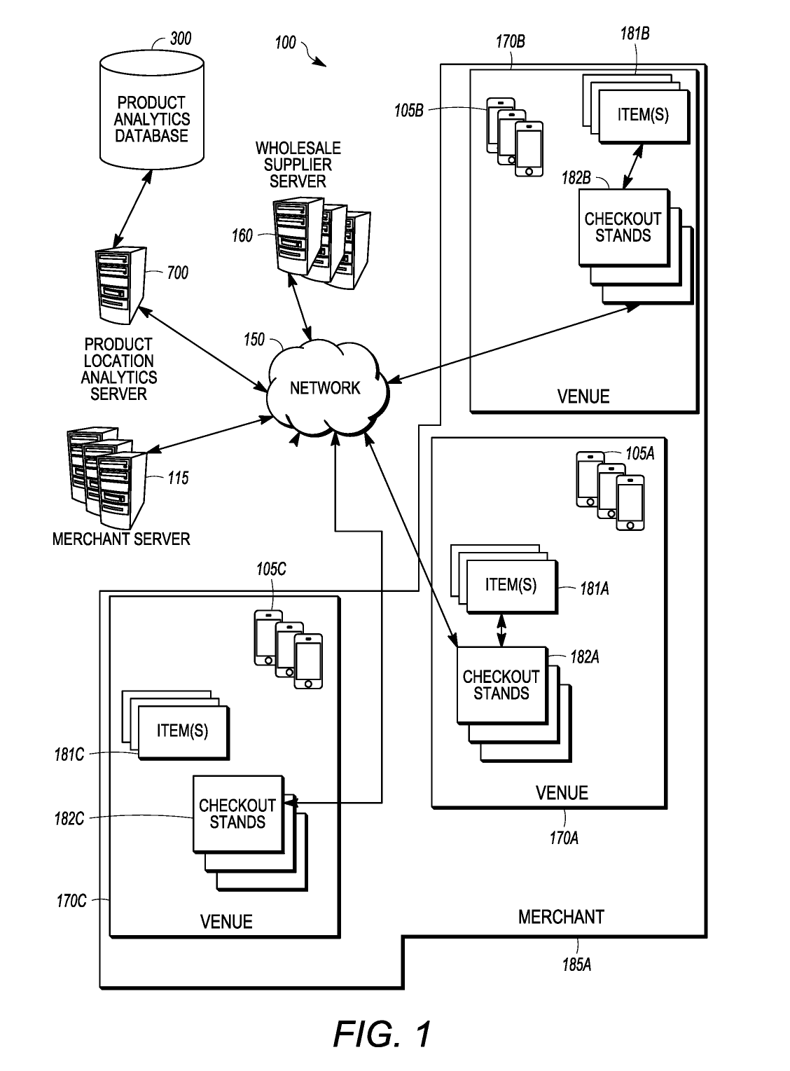

FIG. 1 illustrates an exemplary product location analytics system including a product location analytics server 700 and a product analytics database 300, in accordance with the principles of the present invention.

In particular, as shown in FIG. 1, the product location analytics server 700 may be in communication with a merchant 185 including a single venue 170A, or that includes a plurality of separate venues 170A, 170B, 170C. The venues 170A, 170B, 170C each include a plurality of point-of-sale terminal checkout stands 182A, 182B, 182C that each provide point of sale (POS) transaction information relating to a respective catalog of items 181A, 181B, 181C available in the respective store (venue) 170A, 170B, 170C. Point of sale transaction information may be obtained from a network element other than directly from POS terminal checkout stands 182A, 182B, 182C, e.g., from a store server, within the principles of the present invention.

Each ‘checkout stand’ as referred to herein may be either a single POS terminal (cash-register) or a cluster of two, three or four (or more) POS terminals arranged in very close proximity to each other. Location of the checkout stand can be temporary or permanent so as to accommodate a mobile environment, e.g., use of a mobile device such as a mobile phone or smart phone for checkout, or use of a mobile handheld scanner device provided by the retailer for use within the store.

Mobile devices 105A, 105B, 105C may be used as mobile payment devices by customers at the POS checkout stands 182A, 182B, 182C to complete sale transactions of particular items 181C. Such transactions are included within POS transaction data utilized by a product location analytics server 700 of the present invention. Of course, other traditional payment methods may alternatively be used, e.g., a credit card, debit card, cash, etc. Each POS checkout stand 182A within a given venue 170A preferably provides transactional receipt data for each purchase made to an appropriate merchant server 115 via a network 150. In accordance with the invention, the transactional receipt data is either directly or indirectly forwarded to or accessible by the product location analytics server 700, in accordance with the principles of the present invention.

The product location analytics server 700 or the merchant server 115 may filter the POS transaction receipt data as desired, e.g., to purchases made during the most recent day, week, month, quarter, year, etc. The POS transaction receipt data may also be filtered by time of day (e.g., between 5 pm and 9 pm local time), etc. Ideally, the POS transaction receipt data is filtered to provide a most accurate reflection of a time in a given venue when it is most likely that checkout stands closest to a purchased item will be utilized most frequently. For example, during rush times when movement about the store may be more difficult.

RFID or other location tracker or beacon devices may be associated with some of the retailer's catalog items 181A, 181B, 181C as a source of audit location data.

FIG. 1 depicts a merchant 185 having a plurality of venues 170A, 170B, 170C thus disclosing that the present invention relates equally to product location analytics for item catalogs relating to larger retail merchants having a plurality of venues 170A, 170B, 170C. In disclosed embodiments, each venue 170A, 170B, 170C has its own layout, its own point of sale (POS) transaction data, its own uniquely identified checkout stands, etc. Of course, it is within the scope of the invention for a retail system having a number of stores with nearly identical floor plans and nearly identical planograms to utilize POS transaction data from any of their similar stores as input to the location analytics system for any other of their similar stores.

CAD floor plan(s) in some embodiments may divide the venues 170A, 170B in the y-coordinate by aisles, rows and the like, and may be associated with a size of the aisle, row, or the like (such as, for example, 7′-7″). The CAD floor plan(s) of the venues 170A, 170B in these embodiments are divided in the x-coordinate by bay, section, shelving units, and the like. Some sections may occupy an entire row (a y-coordinate unit), or a portion of a row (an x-coordinate within a y-coordinate unit). The CAD floor plan(s) of the venues 170A, 170B may further comprise z-values for layers of shelves, shelf sections, or the like, and/or such z values may be represented by additional layers in CAD floor plan(s). Components of the CAD floor plan(s) which describe the occupation of space such as rectangular units, areas, points, anchor points (which may indicate the starting point for measuring a distance), dimensions, identification of aisles, sections or bays and the like shall be referred to herein as “spatial units.” The spatial units in the CAD floor plan(s) may correspond to standard units, such as a 2′ or 4′ lengths, 2′ by 4′ rectangles, and the like or may have non-standard defined dimensions.

Item unique identifier(s) such as a SKU, UPC, or product name or number, a barcode or the like, are preferably used to identify items.

An error radius for an assigned location of any item may be set, and used to identify an uncertainty in the location assigned to an item. The error radius or perimeter is preferably relative to the determined location (or relative to a center of a determined location). The error radius may be a circular radius, a non-circular area such as a rectangular area within an aisle (as may fit within a circular radius, factoring in the shape of the venue and utilization of spatial units such as aisles), or the like.

Blocks in FIG. 1 enclosing the merchant 185 with venues 170A, 170B, 170C are logical blocks, not necessarily indicating physical boundaries. Venues 170A, 170B, 170C may be buildings, such as stores comprising merchandise items for sale, at multiple distinct geographic locations. POS terminal checkout stands 182A, 182B, 182C may be, for example, cash registers, checkout stands, clusters of the same, or equivalent devices capable of facilitating the completion of a transaction to purchase an item. Moreover, while the disclosed embodiments relate to POS terminal checkout stands 182A, 182B, 182C being at fixed locations within the store, the present invention relates equally to the use of a mobile POS terminal checkout stands so long as the POS transactional data includes a location of the mobile POS terminal checkout stand at the time of purchase, or information sufficient to determine a location of the mobile POS terminal checkout stand at the time of a given POS transaction.

Mobile payment devices 105A, 105B, 105C may be, for example, mobile phones, smart phones, tablet computers, laptop computers, or the like. The merchant server 115 and wholesale supplier server 160 may be, for example, computers utilized by merchants, and suppliers to merchants, respectively.

Connection to the network 150 shown in FIG. 1, or direct connection between computing devices, may require that the computers execute software routines which enable, for example, the seven layers of the Open System Interconnection (OSI) model of computer networking or equivalent in a wireless phone or wireless data network. The network 150 comprises computers, network connections among the computers, and software routines to enable communication between the computers over the network connections. The network 150 may comprise, for example, an Ethernet network and/or the Internet. Communication among the various computers and routines may utilize various data transmission standards and protocols such as, for example, the application protocol HTTP. Transmitted data may encode documents, files, and data in various formats such as, for example, HTML, XML, flat files, and JavaScript Object Notation (JSON).

While components may be discussed herein as connecting to the product location analytics server 700 or to the product analytics database 300, it should be understood that such connections may be to, through, or via the other of the two components. References herein to “database” should be understood as equivalent to “datastore”. The merchant server 115, the wholesale supplier server 160, the POS terminal checkout stands 182A, 182B, 182C, and the mobile payment devices 105 may comprise a database. Although illustrated in the figures as components integrated in one physical unit, the computers, servers and databases may be provided by common, separate, or distributed physical hardware and common (or separate) logic processors and memory components.

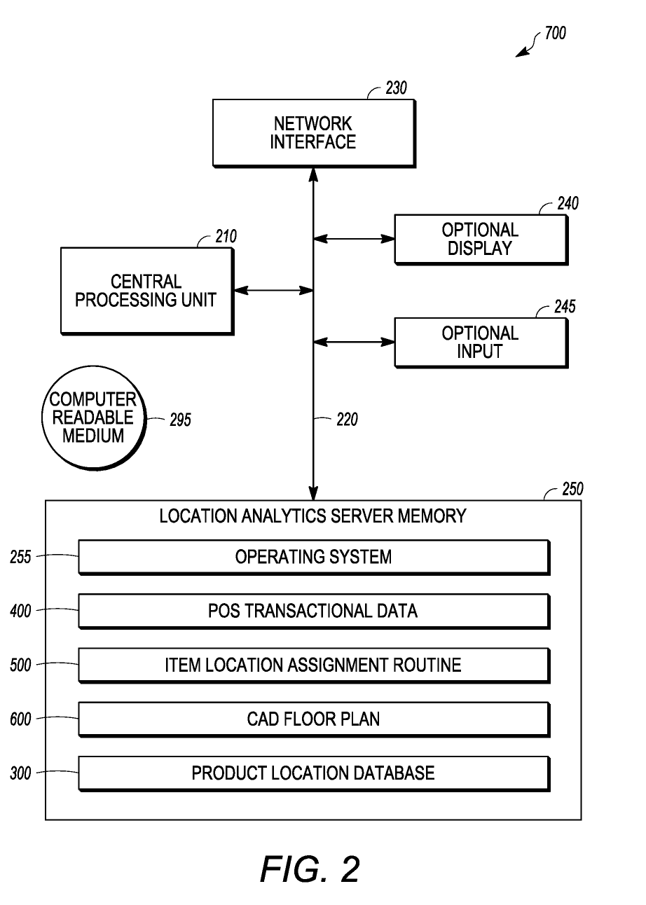

FIG. 2 is a functional block diagram of an exemplary product location analytics server 700 and relevant data structures and/or components thereof. The product location analytics server 700 comprises at least one CPU processing unit 210, location analytics server memory 250, an optional display 240, an optional input device 245 (e.g., keyboard), and a network interface 230, all interconnected via a bus 220. The network interface 230 may be, e.g., an Ethernet interface, and may be utilized to form connections with the network 150 (FIG. 1). The network interface 230 may be wired and/or wireless.

A DVD, USB thumb drive, or other computer readable medium 295 may preferably be used by the product location analytics server 700 via a suitable interface (e.g., a DVD player, or a USB interface, respectively). The POS transaction receipt data may be input to the product location analytics server 700 via the network 150, or via the computer readable medium 295 or other appropriate data input device such that potential mediums to hold POS data include a DVD, CD-ROM, memory card, or USB thumb drive.

The location analytics server memory 250 generally comprises a random access memory (“RAM”) such as SDRAM (synchronous dynamic random-access memory) and/or a permanent mass storage device, such as a disk drive. The location analytics server memory 250 stores program code for software routines, as well as browser, webserver, email client and server routines, camera, other client applications, and database applications. In addition, the location analytics server memory 250 also stores an operating system 255. Software components may be loaded from the non-transient computer readable storage medium 295 into the location analytics server memory 250 using a drive mechanism (not shown) associated with a non-transient computer readable storage medium 295, such as a DVD/CD-ROM drive, memory card reader, USB bus, etc. In some embodiments, software components may also or instead be loaded via a mechanism other than a drive mechanism and a computer readable storage medium 295, e.g., via the network interface 230.

The input 245 of the product location analytics server 700 may comprise hardware supported input modalities such as, for example, a touchscreen, a keyboard, a mouse, a trackball, a stylus, a microphone, an accelerometer(s), a compass(es), RF receivers (to the extent not part of the network interface 230), and/or a camera.

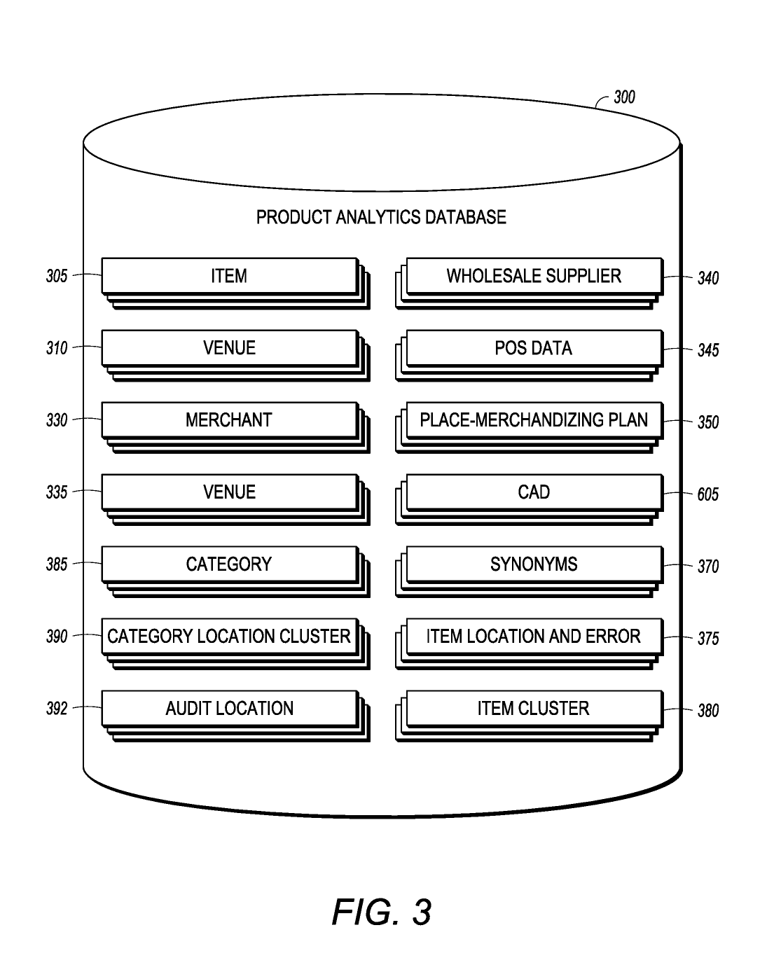

The product location analytics server 700 may comprise, or communicate with via the bus 220, the product analytics database 300, illustrated in detail in FIG. 3. In some embodiments, the product location analytics server 700 may communicate with the product analytics database 300 via the network interface 230. The product location analytics server 700 may, in some embodiments, include many more components than those shown.

Referring again to FIG. 2, the product location analytics server 700 may comprise various data groups and control routines, which are discussed at greater length herein. Webserver and browser routines may provide an interface for interacting with the other computing devices illustrated in FIG. 1, such as with the merchant server 115, the wholesale supplier server 160, and even in other embodiments indirectly with the mobile payment devices 105, (all which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 3 is a functional block diagram of an exemplary product analytics database 300 including data utilized and created by the product location analytics server 700, in accordance with the principles of the present invention.

In particular, a primary purpose of the product location database 300 is to maintain a reliable and complete database including a location of every item in a retailer's product line or catalog.

In addition to the data groups explicitly illustrated in FIG. 3, additional data groups may also be present on and/or executed by the product location analytics server 700. Moreover, routines for databases, webservers, and web browsers, and routines enable communication with other computers. The data groups used by routines may be represented by a cell in a column or a value separated from other values in a defined structure in a digital document or file. Though referred to herein as individual records or entries, the records may comprise more than one database entry. The database entries may represent, or encode numbers, numerical operators, binary values, logical values, text, string operators, joins, conditional logic, tests, and similar. The browser routines may provide an interface for interacting with other computers through, for example, a webserver routine (which may serve data and information in the form of webpages). The web browsers and webservers are meant to illustrate or refer to user-interface and user-interface enabling routines generally, and may be replaced by equivalent routines for serving and rendering information to and in a user or device interface. Log-in credentials and local instances of user or device profiles may be stored in or be accessible to the product location analytics server 700, the merchant server 115, and/or the wholesale supplier server 160. User or device profiles may be utilized to provide secure communication between computers.

The software routines, as well as data groups used by the software routines, may be stored and/or executed remotely relative to any of the computers.

The components of the product analytics database 300 are data groups used by routines and are discussed further herein. Though referred to herein as individual records or entries, the records may comprise more than one database entry. The database entries may be, represent, or encode numbers, numerical operators, binary values, logical values, text, string operators, joins, conditional logic, tests, and similar. In addition to the data groups used by routines, log-in credentials and local instances of customer and user profiles may be stored in or be accessible to all of the computing devices illustrated in FIG. 1.

It is recognized that items in a store or venue are of course located or displayed at a given location (e.g., on a given rack, or folded on a shelf in a given fixture within the store or venue). It is also appreciated that in larger department stores, checkout stands are typically distributed throughout the store, e.g., with one checkout stand, or a cluster of checkout stands, within each department. The location analytics system in accordance with the present invention makes use of the relationship between the location of items in a store and the need to present the same at a checkout stand to complete a purchase.

For purposes of the present invention, any suitable location assignment system for building the item location database 375 within or associated with the product location database 300 may be implemented. For instance, one suitable location assignment system for assigning location to all items in a store or venue is disclosed in co-owned U.S. Pat. No. 9,824,388, the entirety of which is explicitly incorporated herein by reference.

Another suitable location assignment system for assigning location to all items in a store or venue is disclosed in co-owned U.S. application Ser. No. 15/702,595, the entirety of which is explicitly incorporated herein by reference.

Still another suitable location assignment system for assigning location to all items in a store or venue is disclosed in co-owned U.S. application Ser. No. 15/814,308, the entirety of which is explicitly incorporated herein by reference.

Ideally the location assignment system implemented to build the item location database 375 has the capability to recognize and accommodate items inside the store that move on a daily basis, and assigns and stores a location based on the items' new location. For instance, in a location assignment system disclosed in U.S. application Ser. No. 15/833,402, filed Dec. 6, 2017, point of sale (POS) transaction data may be used to generate a physical location of items available within a store. Point of sale based, checkout stand anchored location assignment of products is a very scalable solution for large store and multi-store retailers and department stores. The location assignment system assumes that some location anchor is available, as is a regular feed of data that ties items (products) to the location anchors, as well as location data that ties the location anchors to other locations in the store without any anchors. Checkout stands serve as location anchors, and point of sale (POS) terminal checkout receipt data serves to tie the items to checkout stands. U.S. application Ser. No. 15/833,402 is explicitly incorporated herein by reference.

Shopper Traffic Flow Visualization Based on Point of Sale (POS) Transaction Data

Given the ability to obtain accurate and current location information for all items within a store, the present invention provides an improved analytical system useful to merchants and others desiring to increase the efficiency and profitability of a given store or retail system.

The present invention uses point of sale (POS) transaction data to generate analytics providing visualization of traffic flow in a retail location.

In aggregate, knowledge of customer traffic flow might not seem to be capable of providing much meaningful information. However, in accordance with the invention, point of sale (POS) transaction data is articulated, or filtered, by a specific item, or by a specific brand purchased, and visualized to allow specifically interested merchants to see where in a given store that people who bought certain products walked, to see which items or brands were purchased together, and perhaps most importantly to provide information as to the success of impressions made on a customer as they walked between the items that they did ultimately purchase.

In one aspect of the invention, visualizations are generated to provide a visualization of the likely pathways that customers who purchased one type item, or one brand of item, or a specific item, or specific co-purchased items, took.

Thus, using the POS transaction data-based analytics system in accordance with the invention, a visualization of where customers who bought “Scotts” brand items walked within a given store may be generated, for comparison to a visualization of where customers who bought “Rubbermaid” brand items walked within that store. In this way a merchant may identify, e.g., any distinctly different traffic patterns.

Moreover, the generated visualizations provide for the extraction of “advertising data”-like inferences. For instance, with the POS transaction data-based analytics system, a merchant can determine that people who bought Rubbermaid brand items were exposed to certain other brands as a result of their journey (walking) through the store.

This gives visibility into spatial product relationships based on real data, in particular based on customer point of sale (POS) purchase data, and based on spatial layout data for the given store.

Frequent, obvious associations between certain branded items are known based on a significant amount of brute force, labor intensive analytics of relationships between products, i.e., that in general people who buy X also tend to buy Y. This brute force analytics requires an analysis between pricing, deals and other marketing impacts on sales. However, the present invention provides the ability to generate unexpected, unintended, subtle, and perhaps unrelated associations between items available within a same store—particularly when the association is a result of a location of the unrelated item.

For instance, the present invention provides the capability to identify a relationship and co-marketing opportunity for bundling between unrelated brands, e.g., Rubbermaid brand products with entirely unrelated Style Selections that even brute force analytics would not have identified.

POS transaction data contains information regarding each customer transaction, e.g., which items were purchased, how many of each item were purchased, what the cost was, the date and time of purchase, etc. Additional POS transaction information may include an identify of the specific POS terminal that handled the purchase, and a frequent buyer account identity. The frequent buyer account identity can be used, in accordance with the principles of the present invention, to tie together separate trips to a given store for a given frequent buyer such that POS transaction data can be combined to identify associations generated between separate shopping trips to the store. For instance, a customer may walk past an item on a first shopping trip, then return three days later to purchase that item.

“Dwell” is a term used herein to refer to bays that contain an item that was purchased.

“Impression” is a term used herein to refer to bays that are walked by or passed on a particular customer's journey through the store between bays that they “dwell” upon.

Routes that a particular customer takes on their shopping journey in a given store are determined somewhat arbitrarily. For instance, in given embodiments, each POS transaction receipt is considered, with the physical location of each item purchased plotted on a map of the given store where purchased.

Then, a starting point for the customer's journey is chosen. For instance, the starting point may be set at a “default” entrance for the given venue/store.

Then, a presumed route taken by the customer may be generated as the shortest path between the nodes formed by the start, each item, and then the checkout POS terminal used for the given POS transaction. Conventional route logic between the nodes is implemented to generate the customer's presumed route through the store based on the items that they purchased on any given shopping trip.

Thus, a unique and novel imagery and visualization of shopper traffic flow based on point of sale (POS) transaction data is generated from a limited, filtered data set based on customer point of sale (POS) transaction receipts.

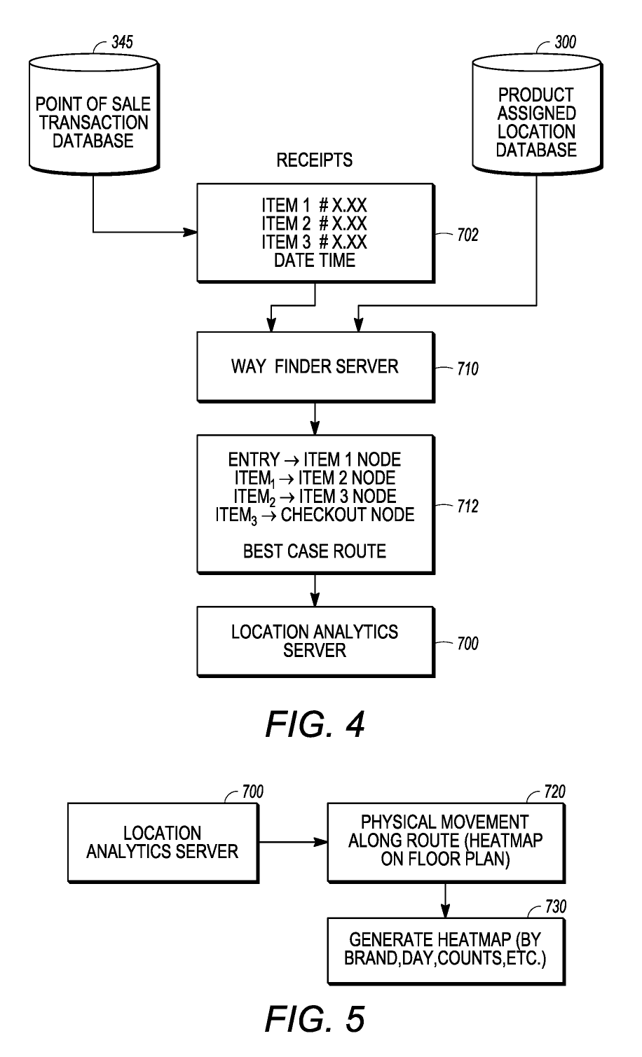

FIG. 4 shows input to a location analytics server 700 in accordance with the principles of the present invention.

In particular, as shown in FIG. 4, point of sale (POS) transaction data collected in a suitable point of sale transaction database 345 provides receipt data to a wayfinder server 710. The receipt data typically includes a list of items purchased, a priced at which they were purchased, and a date and time of the purchase. The receipt data additionally includes an identification of the checkout stand used to make the purchase.

The item location database 375 provides assigned locations for items in the store, e.g., the items purchased on the receipt data 702. The item location database 375 maintains, and provides, the location of all items (products) available in a store to the location analytics server 700.

The wayfinder server 710 obtains the point of sale (POS) receipt data 702 from the point of sale transaction database 345, and the location of each item purchased from the item location database 375. The wayfinder server 710 also obtains the location of the entrance(s) to the relevant store, and the location of checkout registers used. The wayfinder server 710 and the location analytics server 700 may be one and the same server, nevertheless providing their respectively disclosed functionalities.

The wayfinder server 710 then generates the best case route presumably taken by each customer based on a sequence of travel nodes based on their relevant transaction receipt 702. For instance, in the exemplary receipt 702 shown in FIG. 4 wherein the shopper purchased three items (item 1, item 2 and item 3), a best case route is generated for each of the following travel nodes:

NODE 1: From a default entrance to the assigned location of item 1;

NODE 2: From the assigned location of item 1 to the assigned location of item 2;

NODE 3: From the assigned location of item 2 to the assigned location of item 3;

NODE 4: From the assigned location of item 3 to the location of the checkout stand used.

The wayfinder server 710 includes a geographic map of the relevant store(s), including the location of walkways, entrances, and checkout stands. The wayfinder server 710 may also include within the geographic map of the relevant store(s) any other appropriate physical aspect of the store, such as the placement of walls or other barriers. Ideally the geographic map is updated as physical aspects of the store warrant.

In another embodiment, actual shopper location may be monitored by an appropriate location monitoring system, and input directly into the location analytics server 700. For instance, the actual shopper location may be active, e.g., as reported by an appropriate app running on the shopper's mobile device (e.g., smartphone). Alternatively, the actual shopper location may be monitored by beacons or other monitoring devices mounted in the store while the shoppers carry an identifying device such as an RFID tag, or mobile device.

FIG. 5 shows an exemplary output function of the location analytics server 700 wherein a “heat map” is generated by appropriate algorithms performed using the POS transaction data, and location of all items in the relevant store, in accordance with the principles of the present invention.

In particular, as shown in FIG. 5, the location analytics server 700 determines physical movement of each shopper based on their respective POS transaction receipts 702, and plots the shoppers' routes on a floor plan of the store as shown by algorithm 720. In algorithm 730 the location analytics server 700 generates a ‘heat map’ filtered by appropriate parameters chosen by the user. For instance, exemplary parameters to analysis include a heat map of shoppers' routes who purchased a particular brand of goods; or who shopped on a particular day; or who shopped within a window of time on particular days; a particular count of items purchased, etc.

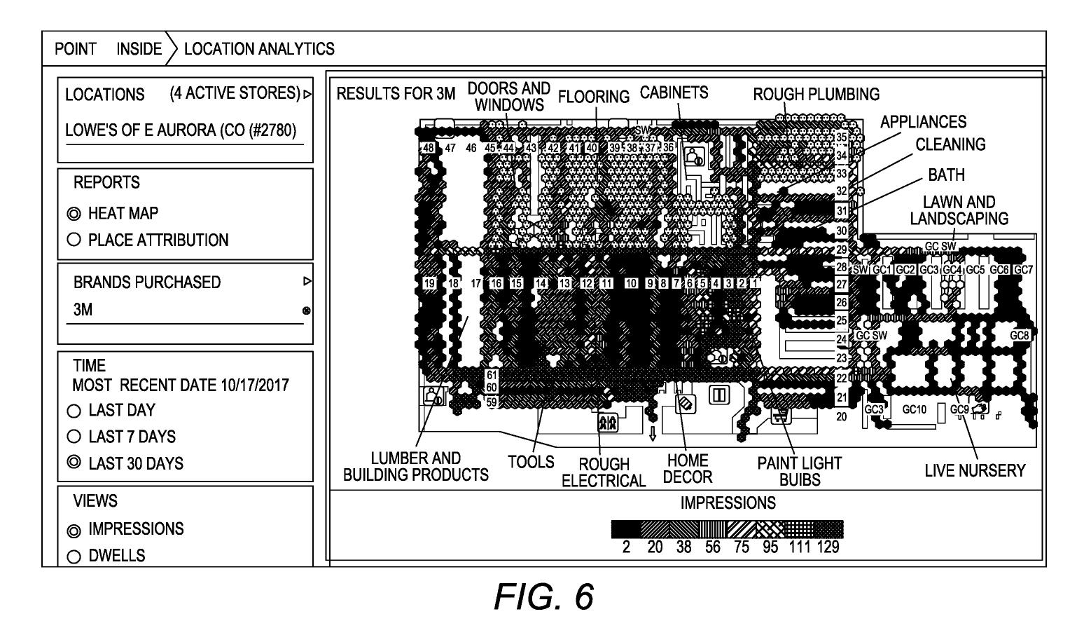

FIG. 6 shows an example of “impressions” for “3M” branded products, e.g., within a period of the past 30 days, depicted as a “heat map”, for a given store, generated by the location analytics server 700, in accordance with the principles of the present invention.

For instance, as shown in the left column of the heat map generated by the location analytics server 700, a particular store within a large retail chain of stores is selected in the “LOCATIONS” parameter.

Generation of a “heat map” visual output is selected in the “REPORTS” parameter.

Input of a filtering parameter “BRANDS PURCHASED” is selected, and one particular brand “3M” is selected in FIG. 6. More than one brand parameter may be selected for an amalgamated result. Moreover, instead of BRANDS PURCHASED, other filtering parameters may be implemented, e.g., COUNTS referring to the number of items purchased. Alternatively, a particular ITEM may be identified for filtering instead of BRANDS PURCHASED; or a CATEGORY of item may be identified for filtering; or a DEPARTMENT of type of items may be identified for filtering.

TIME is shown as being selectable between the “Last Day”, or “Last 7 Days”, or “Last 30 Days”. Of course, any particular time parameter may be implemented, e.g., within the past hour, within the past 6 months, within the past year. Also, a DATE parameter may be implemented, either separate from TIME or together with TIME. Thus, a heat map for customers who made purchases on any given DATE, or combination or DATES may be implemented. Or, combining TIME and DATE filtering parameters, a heat map may be generated for presumed customer paths for items purchased within a selected time slot (e.g., during rush hour 6 pm-9 pm), over the last 7 days, or over the last 30 days, or on every Sunday over the past year, etc.

Lastly, as shown in the VIEWS parameter of the heat map of FIG. 6, the location analytics server 700 may be directed to generate a heat map of “IMPRESSIONS” made by shoppers, or to generate a heat map of “DWELLS” made by shoppers. A heat map of “IMPRESSIONS” shows the number of times that shoppers (as filtered by the relevant parameters) over the filtered time period, walked by or passed directly within view, a bay, as determined by the particular shopper's best case route through the store between the bays at which they purchased an item. A heat map of “DWELLS” shows the frequency at which shoppers (as filtered by the relevant parameters) purchased items from the bays containing the items.

Thus, an impression is logged for each bay (or shelving fixture or other product display) on a path between two purchased items. If the two purchased items were located in the same bay, then no impression is logged other than for the bay containing the purchased items.

In large volume scenarios, the location analytics server 700 may generate a heat map showing normalized, or relative impressions and dwells, rather than an actual count of the impressions or dwells over the requested period of time. This is particularly useful for longer time frames, e.g., customers shopping over the past year.

As shown in FIG. 6, the heat map is depicted using a deepness of a particular color, e.g., blue, based on a number of impressions filtered by the selected parameters, based on POS transaction receipts of shoppers who purchased items over the selected period of time.

As shown in the map of FIG. 6, each level of heat on the heat map is normalized so that the maximum number is represented by the hottest color, and is rounded to a nearest number. For instance, a lowest level of heat shows “2” or more impressions, up to the next heat level which shows “20” impressions, to the next heat level at “38” impressions, to the next heat level at “56” impressions, to the next heat level at “75” impressions, to the next heat level at “93” impressions, to the next heat level at “111” impressions, to the next heat level at “129+” impressions.

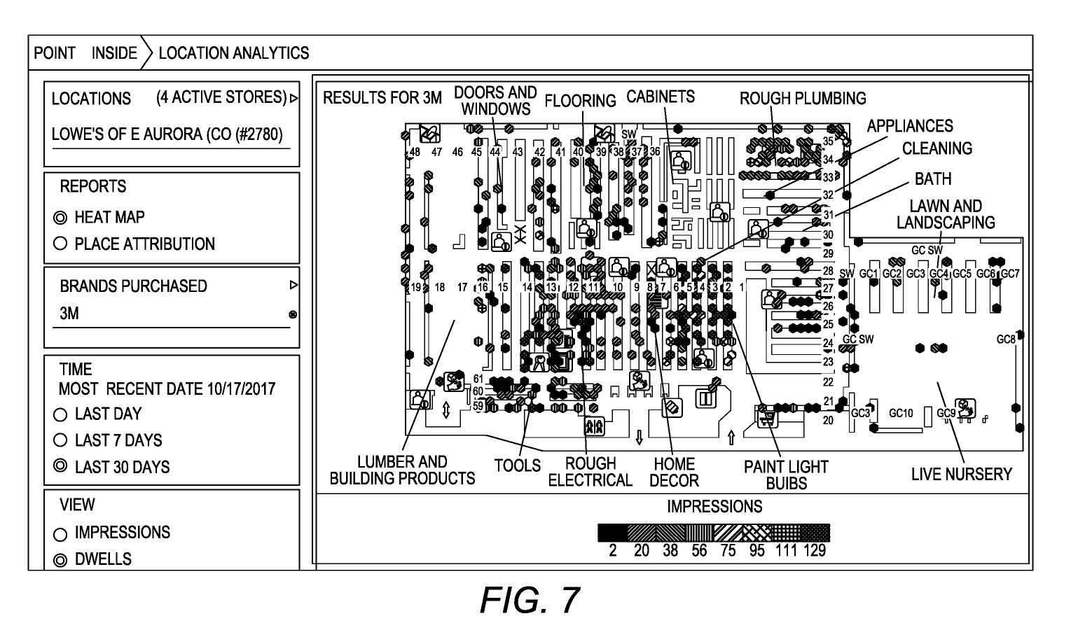

FIG. 7 shows an example of “dwells” for “3M” branded products, e.g., within a period of the past 30 days, depicted as a “heat map”, for a given store.

In particular, FIG. 7 provides the same filtering options as in FIG. 6, but generates a number of “DWELLS”.

Among the useful analytical information provided by comparing the “impressions” shown in FIG. 6 with the “dwells” shown in FIG. 7, for the filtered parameters (e.g., for customers at the selected store who purchased a “3M” product over the last 30 days), is that a main corridor across the lower front of the store, while including checkout registers, etc., resulted in comparatively few dwells, or items purchased, whereas the primary, initial corridor through which customers first enter the store (past the light bulbs and home decor sections up the middle of the store) result in comparatively successful impressions (i.e., purchases from walking past).

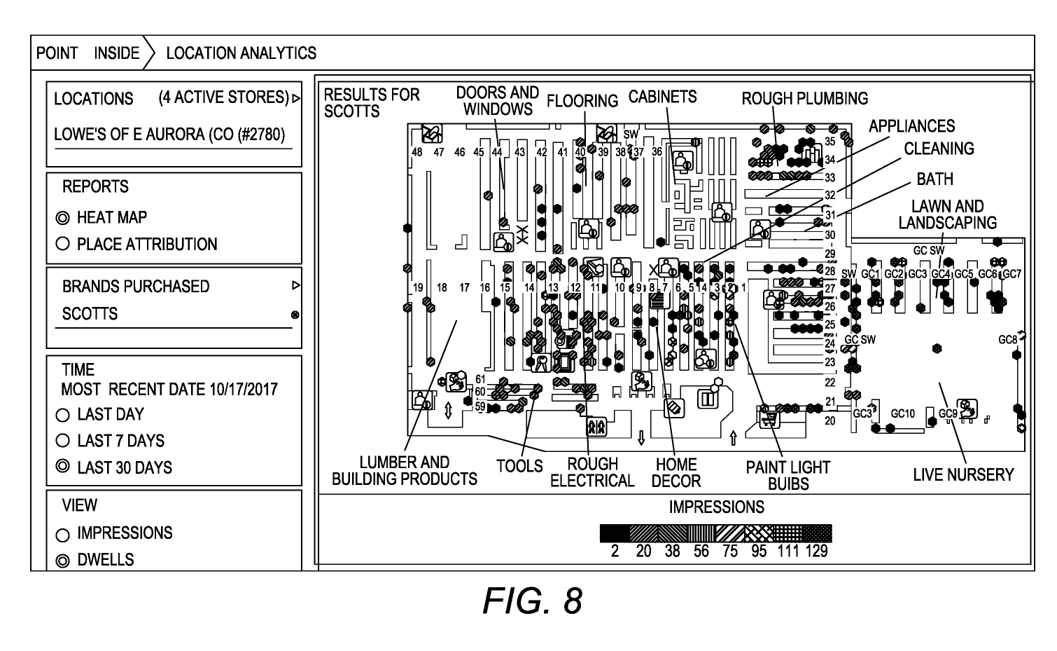

FIG. 8 shows an example of “dwells” for “Scotts” branded products, e.g., within a period of the past 30 days, depicted as a “heat map”, for a given store.

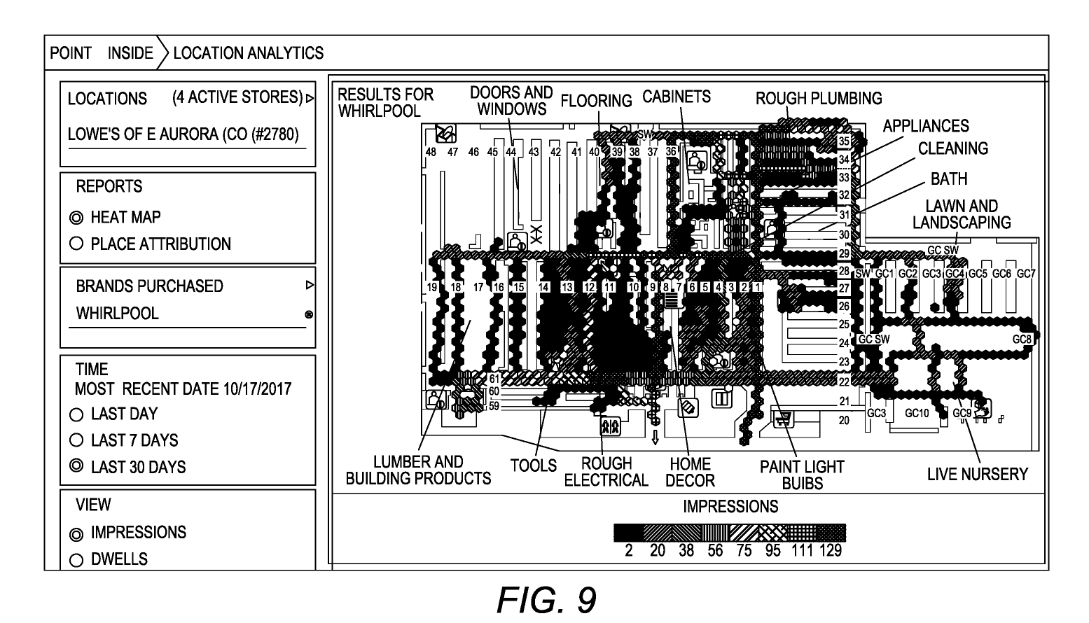

FIG. 9 shows an example of “impressions” for “Whirlpool” branded products, e.g., within a period of the past 30 days, depicted as a “heat map”, for a given store.

The present invention also generated customer “impression” data relating to items or display areas that a given customer did not purchase but were exposed to during their path through a store on a given day. Thus, a merchant is enabled to understand in greater detail that a customer who walked past (and thus “dwelled upon”) mops and other kitchen items did not purchase any of those items but did purchase a “Rubbermaid” bucket.

By definition, the bays in pathways that were walked past with no items purchased may thus be understood as an indication of a non-working impression. When the impression succeeds in getting a shopper to pick up an unintended item on the way, it shows up as a POS purchase (e.g., the “Rubbermaid” bucket).

With statistically sufficient information it may be possible using the present invention to determine a probability that a given shopper may have bought a second item within the “dwell” area because of an “impression” that they experienced on their way to an item that was actually purchased.

For instance, the present invention may identify commonly co-purchased items, and then predict that a third item purchased by a given customer of one (or both) of the co-purchased items was likely caused by their walking by, i.e., the result of a successful impression.

The determination of the success of an impression can also be determined if the intent of a shopper can be inferred based on their POS transaction. For example, if a sufficient number of items are purchased (either on a single POS transaction receipt, or on a number of recent POS transaction receipts tied together through use of a common frequent buyer card), then a probability of the intent of the customer's visit may be inferred, e.g., items typically purchased to build a new sandbox project. Then, if an unrelated item is purchased during a particular one of those shopping visits, it may be inferred that the purchase of that unrelated item is likely to due to a successful “impression”.

Thus, the present invention enables visualization not only as to the quantity of impressions by customers, but also as to the success of those impressions, providing invaluable analytical information for merchants.

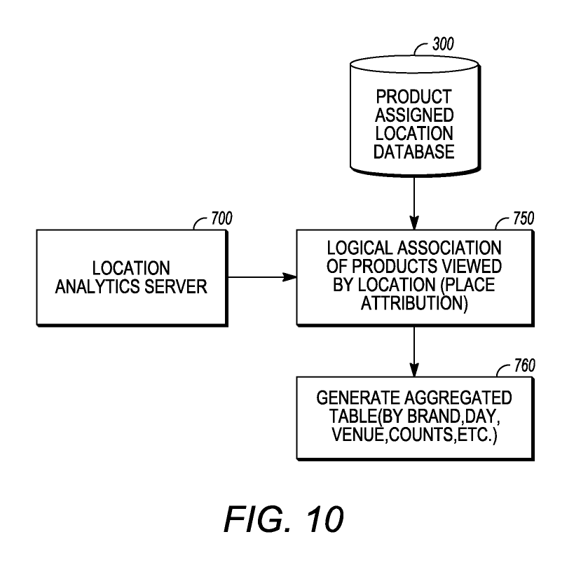

FIG. 10 shows another exemplary output function of the location analytics server 700 wherein a “place attribution table” is generated by appropriate algorithms performed using the POS transaction data, and location of all items in the relevant store, in accordance with the principles of the present invention.

In particular, as shown in FIG. 10, the location analytics server 700 determines physical movement of each shopper based on their respective POS transaction receipts 702, and using location information for all items in the store from the item location database 375, through a logical association of products by location algorithm 750, generates an aggregated table of locations that shoppers either dwelled or experienced impressions, referred to herein as a “place attribution” table filtered by appropriate parameters chosen by the user (the same as in the generation of a “heat map”). For instance, exemplary parameters to analysis include dwells or impressions by shoppers who purchased a particular brand of goods; or who shopped on a particular day; or who shopped within a window of time on particular days; a particular count of items purchased, etc.

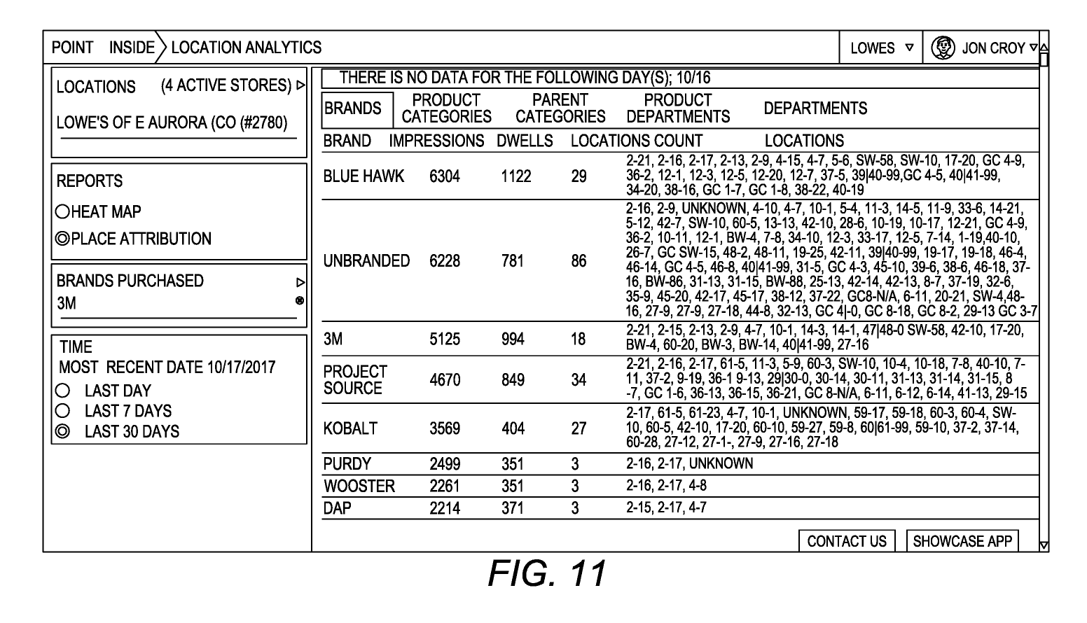

FIG. 11 shows an exemplary place attribution determination for “3M” brands purchased within the past 30 days based on Brands in a given store.

In particular, as shown in FIG. 11, a user not only filters using the LOCATIONS, REPORTS, BRANDS PURCHASED and TIME parameters depicted down the left side of FIG. 11, but also based on “Brands”, “Product Categories”, “Parent Categories”, “Product Departments”, or “Departments”, as shown in the tabs across the top center and right of FIG. 11. In the example of FIG. 11, filtering by “Brands” is selected.

With the “Brands” filtering, the brands are ranked and listed in descending column order of “impressions”. Alternatively, the brands may be ranked and listed in descending column order of “dwells”. Another column included in the place attribution determination may include a “location count”, i.e., a number of distinct bays having either an impression or a dwell by the POS transaction data of shoppers that meet the filtered criteria. Yet another column included in the place attribution determination may list the physical location of each of the locations in the “location count” in any suitable manner appropriate for the store. For instance, the location may be an “aisle/row” type identifier, a map coordinate, an indicator on a planogram, etc.

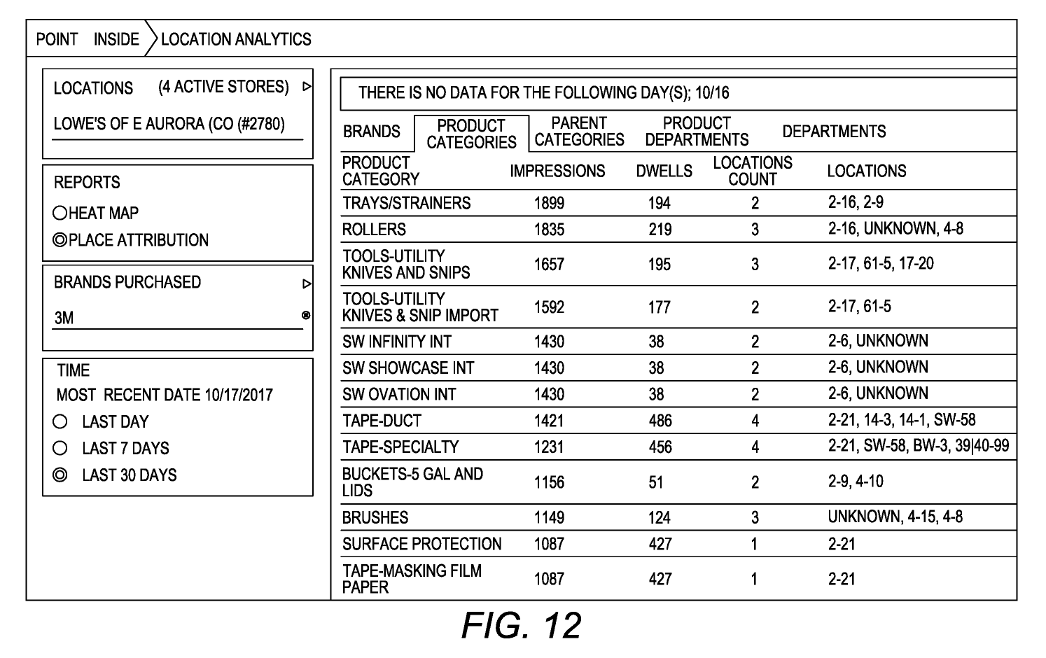

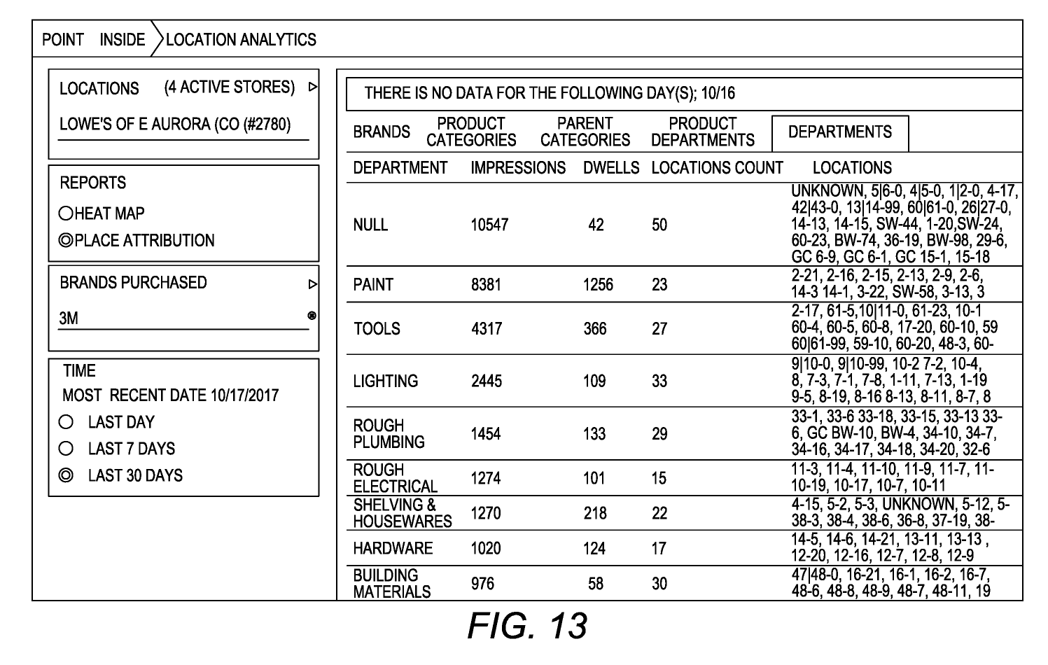

Importantly, “Locations” and “Locations Count” as shown in FIG. 11 (and FIGS. 12-13) relate to the location of a bay, or shelving unit or other display fixture, which holds items available for sale in the store. The assigned location of items as disclosed herein above may (and often will) have additional location information assigned, such as the shelf number on the bay.

Information provided by the generated place attribution determination shown in FIG. 11 includes the articulation that shoppers who purchased a “3M” product, actually purchased more “Blue Hawk” items (6304) than they did “3M” items (5125) as seen in the “impressions” column of the place attribution table. Moreover, it is discovered that shoppers who purchased “3M” items walked by (experienced an impression) “Blue Hawk” bays more frequently than any other product in the store. Thus, the place attribution table provides a clear opportunity to cross-brand “Blue Hawk” products with “3M” products.

FIG. 12 shows an exemplary place attribution determination for “3M” brands purchased within the past 30 days based on Product Categories in a given store.

In particular, FIG. 12 is similar to FIG. 11, but here filtered by “Product Categories” (rather than by “Brands” as in FIG. 11).

Thus, as is articulated by the place attribution table shown in FIG. 12, shoppers who purchased a “3M” product (as filtered in the BRANDS PURCHASED selection on the left-hand side of FIG. 12) dwelled on, and walked by to experience an impression by, “TRAYS/STRAINERS” more than any other type product category over the selected time period (“Last 30 Days”). However, the TRAYS/STRAINERS are located in only two locations (See “Locations Count” of “2”).

FIG. 13 shows an exemplary place attribution determination for “3M” brands purchased within the past 30 days based on Departments in a given store.

In particular, FIG. 13 is similar to FIGS. 11 and 12, but here filtered by “Departments” (rather than by “Product Categories” as in FIG. 12, or by “Brands” as in FIG. 11).

Thus, as is articulated by the place attribution table shown in FIG. 13, shoppers who purchased a “3M” product (as filtered in the BRANDS PURCHASED selection on the left-hand side of FIG. 13) dwelled on, and walked by to experience an impression by, “PAINT” more than any other type product category (other than the “null” category) over the selected time period (“Last 30 Days”). Also, as is determined in the second column “Impressions” and in the third column “Dwells”, the PAINT Department is located in “23” different bays throughout the store. Thus, there may be an opportunity to repurpose one or two of those “23” different bays for a different Department relevant to a cross-marketing opportunity with “3M” brand products.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

Unless the context clearly requires otherwise, throughout the description and the claims, references are made herein to routines, subroutines, and modules. Generally it should be understood that a routine is a software program executed by computer hardware and that a subroutine is a software program executed within another routine. However, routines discussed herein may be executed within another routine and subroutines may be executed independently, i.e., routines may be subroutines and vice versa. As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs or routines having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single computer, processor or controller node or distributed among a plurality of computer, processor or controller nodes running in parallel, concurrently, sequentially or a combination.

While the invention has been described with reference to the exemplary embodiments thereof, those skilled in the art will be able to make various modifications to the described embodiments of the invention without departing from the true spirit and scope of the invention.

What is claimed is:

1. A method of generating item location based shopper dwell based on point of sale transaction data in a store, the method comprising:
associating a physical location to a plurality of bays in a store, each of the plurality of bays including at least one of a plurality of items available at the store;
obtaining point of sale (POS) transaction data for the store;
filtering the POS transaction data to receipts based on at least one of a date and time of purchase, and further filtering the POS transaction data to receipts based on at least one parameter of items purchased, to obtain filtered receipts;
obtaining an assigned location of each item purchased in the filtered receipts;
determining the dwell locations of each item purchased on each of the filtered receipts;
sorting the dwell locations based on a particular attribute of the items dwelled upon into a column or row; and
visually outputting the sorted column or row of particular attribute of the items dwelled upon.

2. The method of generating item location based shopper dwell based on point of sale transaction data in a store according to claim 1, wherein the at least one parameter of items purchased comprises:
a brand of the item purchased.

3. The method of generating item location based shopper dwell based on point of sale transaction data in a store according to claim 1, wherein the attribute of items comprises:
a brand of the items.

4. The method of generating item location based shopper dwell based on point of sale transaction data in a store according to claim 1, wherein the attribute of items comprises:
a category of the items.

5. The method of generating item location based shopper dwell based on point of sale transaction data in a store according to claim 1, wherein the attribute of items comprises:
a department of the items.

6. The method of generating item location based shopper dwell based on point of sale transaction data in a store according to claim 1, further comprising:
obtaining a location of all items in the store.

7. The method of generating item location based shopper dwell based on point of sale transaction data in a store according to claim 1, wherein the visually outputting comprises:
generation of a “heat map”.

8. The method of generating item location based shopper dwell based on point of sale transaction data in a store according to claim 1, wherein the dwell locations for each filtered receipt include:
a location of a checkout stand used for the relevant purchase; and
a location of an entrance to the store.

9. A method of generating item location based shopper impressions based on point of sale transaction data in a store, the method comprising:
associating a physical location to a plurality of bays in a store, each of the plurality of bays including at least one of a plurality of items available at the store;
obtaining point of sale (POS) transaction data for the store;
filtering the POS transaction data to receipts based on at least one of a date and time of purchase, and further filtering the POS transaction data to receipts based on at least one parameter of items purchased, to obtain filtered receipts;
obtaining an assigned location of each item purchased in the filtered receipts;
defining a plurality of travel nodes between each item purchased on each of the filtered receipts;
determining a best route in the store for each of the plurality of travel nodes;
determining impression locations of each bay passed along the plurality of travel nodes;
sorting the impression locations based on a particular attribute of the items impressed upon into a column or row; and
visually outputting the sorted column or row of particular attribute of the items impressed upon.

10. The method of generating item location based shopper impressions based on point of sale transaction data in a store according to claim 9, wherein the at least one parameter of items purchased comprises:
a brand of the item purchased.

11. The method of generating item location based shopper impressions based on point of sale transaction data in a store according to claim 9, wherein the attribute of items comprises:
a brand of the items.

12. The method of generating item location based shopper impressions based on point of sale transaction data in a store according to claim 9, wherein the attribute of items comprises:
a category of the items.

13. The method of generating item location based shopper impressions based on point of sale transaction data in a store according to claim 9, wherein the attribute of items comprises:
a department of the items.

14. The method of generating item location based shopper impressions based on point of sale transaction data in a store according to claim 9, further comprising:
obtaining a location of all items in the store.

15. The method of generating item location based shopper impressions based on point of sale transaction data in a store according to claim 9, wherein the visually outputting comprises:
generation of a “heat map”.

16. The method of generating item location based shopper impressions based on point of sale transaction data in a store according to claim 9, wherein the travel nodes for each filtered receipt include:
a location of a checkout stand used for the relevant purchase; and
a location of an entrance to the store.

17. A non-transient computer-readable storage medium having stored thereon instructions that, when executed on a processor, configure the processor to generate item location based shopper impressions based on point of sale transaction data in a store, by:
associating a physical location to a plurality of bays in a store, each of the plurality of bays including at least one of a plurality of items available at the store;
obtaining point of sale (POS) transaction data for the store;
filtering the POS transaction data to receipts based on at least one of a date and time of purchase, and further filtering the POS transaction data to receipts based on at least one parameter of items purchased, to obtain filtered receipts;
obtaining an assigned location of each item purchased in the filtered receipts;
defining a plurality of travel nodes between each item purchased on each of the filtered receipts;
determining a best route in the store for each of the plurality of travel nodes;
determining impression locations of each bay passed along the plurality of travel nodes;
sorting the impression locations based on a particular attribute of the items impressed upon into a column or row; and
visually outputting the sorted column or row of particular attribute of the items impressed upon.
